(19) United States
(12) Patent Application Publication
(10) Pub. No.: US 2007/0255815 A1
(43) Pub. Date: Nov. 1, 2007

(54) Software, Systems, and Methods for Secure, Authenticated Data Exchange

(75) Inventors: James Justice, San Francisco, CA (US); Dale Fong, Alameda, CA (US)

Correspondence Address: DAVID P. LENTINI, 1932 CALIFORNIA STREET, SAN FRANCISCO, CA, 94109-4407, US

(73) Assignee: UDX, Inc.

(21) Appl. No.: 11/734,789

(22) Filed: Apr. 13, 2007

Related U.S. Application Data
(60) Provisional application No. 60/795,479, filed on Apr. 27, 2006.

(51) Int. Cl. G06F 15/173

(52) U.S. Cl. 709/223

(57) ABSTRACT

Systems, methods, and software for the secure exchange of electronic information are provided. In a first aspect, the present invention provides a system for secure electronic information exchange, comprising a secure electronic communications server computer in secure electronic communication with at least one sender of electronic information and at least one receiver of electronic information. The secure electronic communications server computer is configured to receive securely electronic information sent from the at least one sender of electronic information addressed to the at least one receiver of electronic information and forward the electronic information to the at least one receiver of the electronic information. A database including descriptive information effective to enable the authentication of the at least one sender of electronic information and the at least one receiver of electronic information is also provided.

### 1 CROSS REFERENCE TO RELATED U.S. PATENT APPLICATIONS

This application claims priority under 35 U.S.C. § 119(e) to provisional U.S. Patent Application Ser. No. 60/791,792, filed 12 Apr. 2006; and U.S. Patent Application Ser. No. 60/795,479, filed 26 Apr. 2006. The disclosure of each of these provisional U.S. patent applications is incorporated herein by reference in its entirety and for all purposes.

### 2 COPYRIGHT NOTICE

A portion of the disclosure of this patent document contains material that is subject to copyright protection. The copyright owner has no objection to anyone reproducing the patent disclosure as it appears in the Patent and Trademark Office patent files or records. However, the copyright owner strictly reserves all other copyrights.

### 3 BACKGROUND OF THE INVENTION

3.1 Field of the Invention

The present invention provides software, systems, and methods for securely transmitting and authenticating electronic information, including electronic documents and electronic mail. The invention has applications in the fields of computer science, computer networking, computer security, and business methods.

3.2 The Related Art

The exchange of information in electronic form, such as electronic files, electronic documents, and electronic mail (“e-mail”) has become the dominant form of data exchange throughout the industrialized world. Exchanging information in electronic form over computer networks, e.g., the Internet, allows nearly instantaneous distribution and access to information. Thus, workers in the so-called “knowledge economy” have experienced marked gains in productivity by greatly increasing the efficiency of information dissemination and exchange, which allows correspondingly faster productivity.

But the increase in speed and productivity has come with a price. Although documents and e-mails can move across the globe at nearly the speed of light, the information itself is far more vulnerable to compromise. The ephemeral nature of electronic information allows greater opportunities for unauthorized access and alteration, since the data can be intercepted in transit or at an intermediate storage point. Also, the ease with which a sender can choose addressing and routing options also creates a greater likelihood of erroneous addressing.

For example, in general e-mail is an open-ended communication network. The recipient and the sender are typically using different mail servers, provided by different service providers. Anyone can typically join the worldwide e-mail network simply by signing up with a service provider, and a sender can use any name or identification they so choose to be associated with their e-mail address. Thus, a malicious actor can spoof a sender into forwarding sensitive data (e.g., trade secrets or personal financial information) by posing as a trusted receiver, such as a bank official or legal representative. In addition, the openness of e-mail network design has resulted in a significant amount of spam and scams such as the well known “phishing” scams in which malicious senders send out numerous of e-mails spoofing a financial institution that requests a recipient to follow a masked link and “log-in to” the recipient's online account. When the recipient clicks the masked link, however, he is directed to a Web page which looks like the recipient's financial institution; but the Web site is actually the phisher's own Web site. When the recipient inputs the name and password for the account, the phisher acquires that information and now has full access to the recipient's financial account.

Given the grave concerns over security, much effort has been made to provide greater control over the distribution and authenticity of electronic information. Current Digital Signature architectures which can be used to prove (as well as can be proved) the identity of a party in an e-mail transaction have proven to be difficult to understand and use: These methods are complex, expensive, and prone to compromise. Thus, a simple-to-use technology and method for establishing a trusted electronic relationship between parties exchanging electronic information, such as in an electronic mail system, is sorely needed.

### 4 SUMMARY OF THE INVENTION

The present invention provide systems, methods, and software for the secure exchange of electronic information.

In a first aspect, the present invention provides a system for secure electronic information exchange, comprising a secure electronic communications server computer in secure electronic communication with at least one sender of electronic information and at least one receiver of electronic information, the secure electronic communications server computer being configured to receive securely electronic information sent from the at least one sender of electronic information addressed to the at least one receiver of electronic information and forward securely the electronic information to the at least one receiver of the electronic information; a database including descriptive information of the least one sender of electronic information and the at least one receiver of electronic information, the descriptive information being effective to enable the authentication of the at least one sender of electronic information and the at least one receiver of electronic information. The secure electronic communications server computer being further configured to provide at least one estimation of confidence in the authentication.

In some embodiments, the system just described is configured to provide an Authenticity Quotient, which, in some embodiments, comprises a Registration AQ factor and a Signing AQ factor. In more specific embodiments, the above described system also includes at least one secure client computer that is configured to receive instructions from the secure server computer to establish a secure connection with at least one additional secure server computer and receive secure electronic communications from the at least one additional secure server computer.

In another aspect, the present invention provides a computer-readable medium containing computer program code devices thereon that are configured to enable a computer to perform secure electronic information exchange, wherein the computer program code devices are configured to provide a secure electronic communications server computer in secure electronic communication with at least one sender of electronic information and at least one receiver of electronic information, the computer program code devices being further configured to provide secure electronic communications server computer that can receive securely electronic information sent from the at least one sender of electronic information addressed to the at least one receiver of electronic information and forward securely the electronic information to the at least one receiver of the electronic information; computer program code devices configured to provide a database including descriptive information of the least one sender of electronic information and the at least one receiver of electronic information, the descriptive information being effective to enable the authentication of the at least one sender of electronic information and the at least one receiver of electronic information; and computer program code devices configured to provide at least one estimation of confidence in the authentication.

In a third aspect, the present invention provides a method for secure electronic information exchange. In some embodiments, the method of the invention includes providing a secure electronic communications server computer in secure electronic communication with at least one sender of electronic information and at least one receiver of electronic information, the secure electronic communications server computer being configured to receive securely electronic information sent from the at least one sender of electronic information addressed to the at least one receiver of electronic information and forward securely the electronic information to the at least one receiver of the electronic information; providing a database including descriptive information of the least one sender of electronic information and the at least one receiver of electronic information, the descriptive information being effective to enable the authentication of the at least one sender of electronic information and the at least one receiver of electronic information; and providing at least one estimation of confidence in the authentication.

These and other aspects and advantages will become apparent when the Description below is read in conjunction with the accompanying Drawings.

### 5 BRIEF DESCRIPTION OF THE DRAWINGS

FIG. 1 is a schematic depiction of a computer network configured to enable the exchange of electronic information in accordance with the present invention.

FIG. 2 illustrates an example of autosorting in accordance with the present invention.

FIG. 3 illustrates an example of autosorting in accordance with the present invention.

FIG. 4 is a schematic depiction of a method of secure authenticated data exchange in accordance with the present invention.

FIG. 5 is a schematic depiction of a method of secure authenticated data exchange in accordance with the present invention.

FIG. 6 is a schematic depiction of a method of secure authenticated data exchange in accordance with the present invention.

FIG. 7 is a schematic depiction of a method of secure authenticated data exchange in accordance with the present invention.

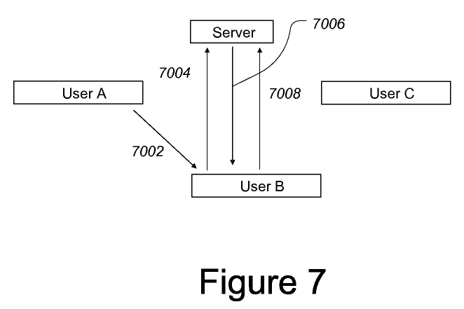

FIG. 8 is a schematic depiction of a method of secure authenticated data exchange in accordance with the present invention.

FIG. 9 is a schematic depiction of a method of secure authenticated data exchange in accordance with the present invention.

FIG. 10 is a schematic depiction of a method of secure authenticated data exchange in accordance with the present invention.

FIG. 11 is a schematic depiction of a method of secure authenticated data exchange in accordance with the present invention.

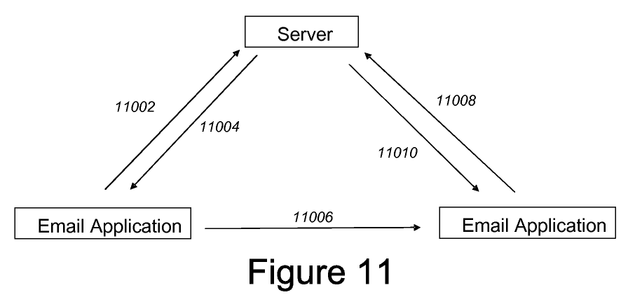

### 6 DESCRIPTION OF SOME EMBODIMENTS OF THE INVENTION

The present invention provides software, systems, and methods for establishing secure and authenticated exchange of electronic information over a computer network. Using the software, systems, and methods provided herein, users can exchange information electronically with greater security that the information will not be compromised, i.e., viewed by those who are note authorized to receive the information or tampered with to mislead the intended recipient, and that the information will be received by the intended receiver.

### 6.1 System

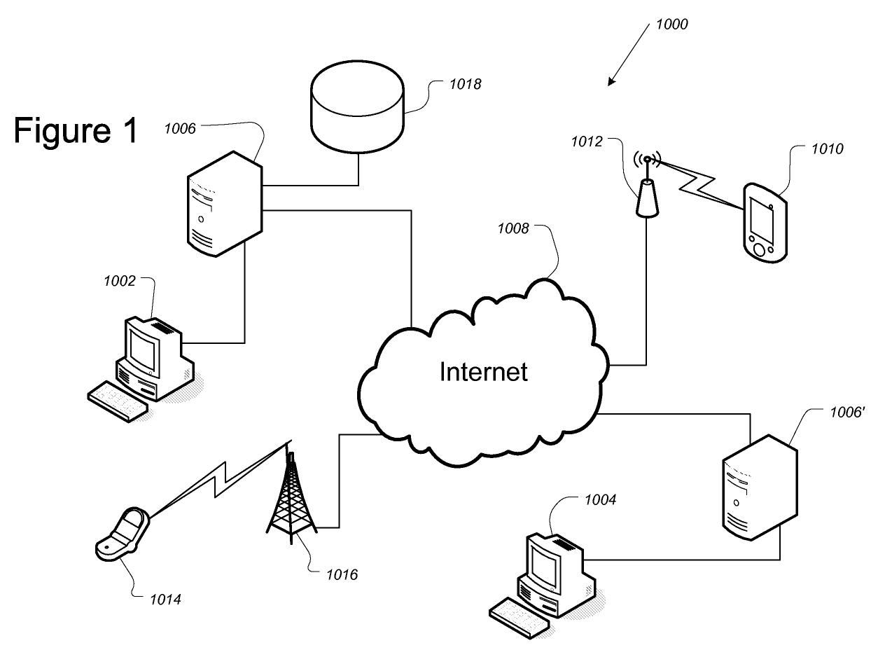

In a first aspect, an example of which is illustrated in FIG. 1, the present invention provides a computer system for secure electronic information exchange (1000). The system (1000) includes at least one sender of electronic information (1002) that communicates with at least one receiver of electronic information (1004) using at least one secure electronic communications server computer (1006) that configured to receive securely electronic information sent from said at least one sender of electronic information addressed to said at least one receiver of electronic information, and forward securely the electronic information to the receiver of the electronic information. In some embodiments, the secure electronic communications server computer includes one or more additional secure electronic communications server computers (1006′). In some embodiments, that the secure server computer can be the same device as the sending computer. Sender (1002), receiver(s) (1004), and server(s) (1006, 1006′) are connected to each other through the Internet (1008), one or more other types of computer networks (e.g., local area networks, LANs), directly, or in some combination of these connections (not shown). In some embodiments, one or more of the electronic connection is secure, e.g., electronic information exchanged between two or more devices is encrypted or otherwise enhanced to reduce or eliminate unauthorized access or tampering. The computers and servers and their connections just described are of standard design and construction, and their operation will be understood by those having ordinary skill in the art.

The system (1000) can include other devices for secure electronic information exchange, including wireless devices communicating with the system, such as, for example, a personal digital assistant (1010) communicating through a base station (1012), or a remote cell phone (1014) by an antenna (1016). Still other devices that can participate in such communication will be apparent to those having ordinary skill in the art. The just described are of standard design and construction, and their operation in accordance with the invention described herein will be understood by those having ordinary skill in the art.

As noted above, the secure electronic communications server computers (1006, 1006′) are of standard construction and operation as will be familiar to those having ordinary skill in the art. In some embodiments, at least one of the secure electronic communications server computers (1006, 1006′) includes one or more databases (1018) in secure electronic communication with the server(s) that provide descriptive information of the sender of the electronic information (1002) and the receiver(s) of the electronic information (1004). In more specific embodiments, the descriptive information is effective to enable the authentication of the sender of the electronic information (1002) and the receiver(s) of electronic information (1004). Examples of information suitable to enable such authentication include, without limitation, address, phone number, personal identifier (such as a photo or symbol) or other information which helps other parties on the system authenticate a user. The registered e-mail address can be the same e-mail address used on publicly accessible email systems, commonly referred to today in common practice as “e-mail” or “Internet e-mail”, a proprietary electronic mail address used on a private email network, or a virtually private email network. Still other types of suitable e-mail address will be apparent to those having ordinary skill in the art. The information can also be arranged in a hierarchal structure such that a user can be identified at various tiers. For example, an identifier could include a company name, a division name, and user name. Thus, if one party in an email exchange wishes to validate the identity of the other party, then the invention provides the means by which the user may do so. Additional information and methods for providing such information to the database will also be apparent to those having ordinary skill in the art. The database may separate from, or integral with (i.e., as a real or virtual data device) the server(s), and such arrangement may be different on different servers in a multiple sever configuration embodiment. Those having ordinary skill in the art will understand how to provid the database(s) just described.

In one embodiment, at least certain aspects of the authenticated ID of the user, such as name and address, at the server must be unchangeable by the user after the user has been authenticated at registration to prevent spoofing. In more particular embodiments all aspects of the authenticated ID are not changeable by the user after authenticated registration. In still more specific embodiments in which either of the foregoing limitations on changing a user's authenticated ID are provided, the only way for the user to effect any such change is to re-register or re-authenticate.

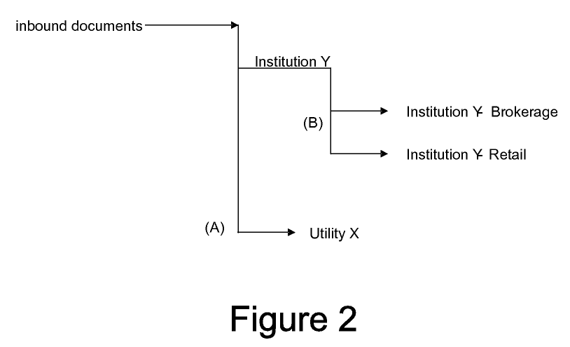

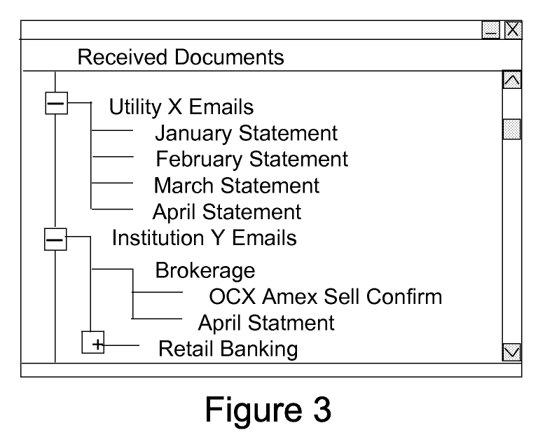

In one embodiment, the server(s) are configured to maintain the identities of individuals or devices such that that their identities can be verified by other individuals sharing the system; thus, the same server(s) facilitate the transmission of a file or document between two or more parties such that a client on the receiving computer can autosort electronic information at the receiver with a degree of certainty of the integrity of the electronic information and the sender's authenticity. As used herein, “autosort” refers to automatically storing received electronic files or messages, and, in some embodiment of the invention automatically storing received electronic files or messages within a hierarchy of electronic folders according to information relevant to the sender, or (sub)class of sender, wherein each folder identified as being associated with the sender or (sub)class of sender (or both). For example and with reference to FIG. 2, if a customer has both a brokerage account with institution Y and a retail banking account with “Institution Y” and a service account with “Utility X”, then inbound electronic information can be routed to an appropriate directory or location in an hierarchal database or other similar data structure. So, when incoming electronic information arrives, the header, or other suitable component of the electronic information is read, and then either: the information is stored with the hierarchical information is embedded in the electronic file; the information is directed to a file or folder (e.g., routed to “Utility X” (A) or a subfolder or “Institution Y” (B); or the email is stored with another independent identifier which references a database which cross references the electronic information hierarchical information stored in the database. A more detailed example of autosorting is shown in FIG. 3. There, a user interface shows an example in which both Utility X and Institution Y have subfolders into which electronic information can be stored upon autosorting.

In a more specific embodiment of the invention, the above-described autosorting of incoming electronic information in implemented at the client (i.e., the receiver of the electronic information). In such embodiments, the client is configured to accept and process the incoming electronic information in accordance with the hierarchical information contained electronic information, e.g., in a file header or an e-mail header.

In another embodiments, the above-described secure electronic communications server computer is further configured to provide at least one estimation of confidence in said authentication. In some more specific embodiments, this feature is provided in addition to the foregoing autosort feature. In other more specific embodiments, this feature is provided without the above-described autosort feature. Methods for generating such estimations are known among those having skill in the art.

In still more specific embodiments, the estimation of confidence is an Authenticity Quotient, which is defined herein as measure, numerical or non-numerical, of the confidence in the authenticity of the identity of a user on the system. In more specific embodiments, the Authenticity Quotient comprises a Registration AQ factor, i.e., a factor representing how the user in question was registered on the system, and a Signing AQ factor, i.e., a measure of the reliability of the sender's identity. In some more particular embodiments, the Registration AQ system is be used to identify a recipient as well; and the recipient must enter his (or her) Signature Code to access the desired information.

In still more specific embodiments, the Registration AQ measures the certainty that a registrant on the system is who they claim to. In one specific embodiment, the Registration AQ is determined by the method of registration. For example, the system:
A.) Can correlate the user's billing method to the user (for example, using the registrant's credit card or bank account name as the account name);
B.) Leverage a pre-existing identity-relationship, such as the login for a bank's website; or
C.) Notarize the user's registration at a physical location.

In general, C) is stronger than B), and B) is stronger than A); so AQ_{C}>AQ_{B}>AQ_{A}. Still other methods will be apparent to those having ordinary skill in the art.

In other more specific embodiments, the Signing AQ measures the degree of certainty that an individual using a digital signature at the time of a transaction (i.e., the time the user sends electronic information) is indeed the individual registered to use that digital signature, or, more inclusively, that the individual is whom the digital signature is officially meant to represent. In some embodiments, the basis of determining the signing AQ is the method used to identify the user at the time of the transaction. Following are exemplary illustrative methods:
A.) Software application access, which relies on access to the desktop containing an application registered on the system being restricted to the intended (registered) user;
B.) Passcode (electronic signature): The user has to choose a secret passcode or signature code at registration that is used to identity the sender at the time of a transaction;
C.) Biometric identifier: A biological identifier determined at registration (e.g., voice print or fingerprint) is used to identify the sender at the time of a transaction; or
D.) Full digital notarization: The user digitally signs a document in the presence of a notary, who then electronically signs the document as well.

In general, D) is stronger than C), C) is stronger than B), and B) is stronger than A); so AQ_{D}>AQ_{C}>AQ_{B}>AQ_{A}. Still other methods will be apparent to those having ordinary skill in the art.

In another embodiment, at least one secure client computer is configured to receive instructions from the secure server computer to establish a secure connection with at least one additional secure server computer and receive secure electronic communications from the additional secure server computer(s). Such a connection can be direct or through intermediate servers and routers. Thus, for example, where the secure communication is an e-mail or file, the recipient's client e-mail application can be dynamically directed to retrieve the e-mail or file from a specific email server and request the delivery of said email or file directly from the that server, in effect generating a dynamic “peer-to-peer (P2P)” transaction.

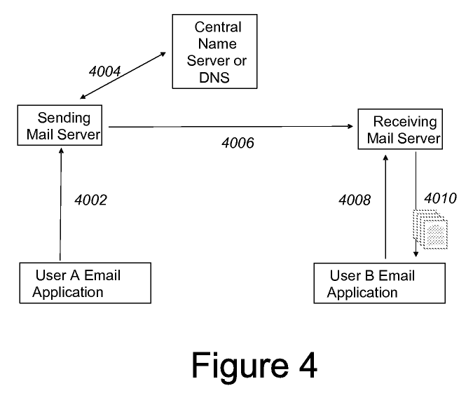

For example with reference to FIG. 4, in a typical e-mail architecture, there are a various sending mail servers, receiving mail servers, and user e-mail applications that communicate with the sending and receiving mail servers. Typically each e-mail account in an email application is assigned a static sending and a static receiving email server/server address. In a simplified normal sending procedure, a User A addresses an email to User B in email Application A. Email application A sends the message (4002) to the Sending mail server which then, directly or indirectly, does a lookup (4004) at a central directory (or DNS in the case of common internet email) to find out what Receiving Mail Server is assigned to User B. Once the address of the receiving mail server is identified, the email is then sent, via the network, to the Receiving mail server (4006). The User B email application regularly asks (pings) the Receiving mail server if there is any inbound mail for User B (4008). The Receiving mail server responds with the email which is sent to the User B email application (4010).

In another example, where the sending email is outside of a closed organization or enterprise, where the Sending party can often use and control its own Sending mail server, the Receiving mail server (or any interim servers) is (are) typically unknown and not controlled by the Sending party. This can be troublesome when the sending party considers the contents of an email sensitive material and doesn't wish to trust a third party with the information. It also requires that a third party server “relay” the email which creates unnecessary traffic for the Receiving mail server, as well as the network, where a direct send between the Sending mail server and User B email application would be more efficient. In some embodiments in which a “relay” transaction as just described is used, the receiving mail server can be part of the secure server. The methods and systems of the present invention provide two exemplary solutions:

### 6.1.1 Method 1

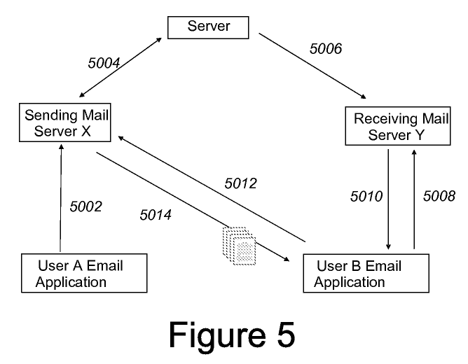

Referring to FIG. 5, user A inputs an email address in User A email application and clicks “send” (5002). The User A email application then sends the email to the Sending mail server X (5004). The Sending mail server X then notifies a central server (containing a registry of all email users), that an email is being sent from the Sending mail server X to User B (or User B's email application) and passes a unique transaction identifier or email identifier (token or other) to the Server (5006). The Server then notifies Receiving mail server Y that Sending mail server X has an email for User B passing along the email identifier (5008). User B email application regularly asks (pings) Receiving mail server Y if there is any mail for User B (5010). The Receiving mail server responds “yes” and includes in the response the address of the Sending mail server X along with the email identifier (5012). The User B email application then sends a request directly to the Sending mail server X, passing along the email identifier and requesting the email (5014). The email is then sent from Sending mail server directly to the User B email application.

### 6.1.2 Method 2

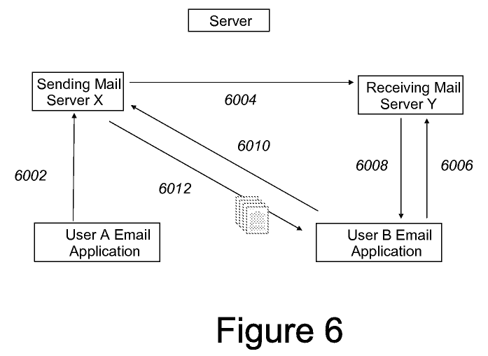

Referring now to FIG. 6, the Sending mail server could have cached (from a previous transaction or could actually have the address permanently stored) the address of User B's Receiving mail server (in this case Receiving mail server Y). In which case, a User A inputs an email address in User A email application and clicks “send” (6002). The User A email application then sends the email to the Sending mail server X (6004). The Sending mail server X then performs a local lookup in its own tables to find the address of Receiving mail server Y, then notifies Receiving mail server Y that an email is being sent from the Sending mail server X to User B (or User B's email application) and passes a unique transaction identifier or email identifier (token or other) to the Receiving mail server Y (6006). User B email application regularly asks (pings) Receiving mail server Y if there is any mail for User B (6008). The Receiving mail server responds “yes” and includes in the response the address of the Sending mail server X along with the email identifier (6010). The User B email application then sends a request directly to the Sending mail server X, passing along the email identifier and requesting the email (6012). The email is then sent from Sending mail server directly to the User B email application.

A combination of the two illustrative methods also allows the Sending mail server X to perform a local lookup (at Server X) to see if it has stored the address of User B's Receiving mail server; and, if so, to utilize Method 2 to send the email, and, if not, utilize Method 1 to send the email.

In each of the foregoing cases, the term “server” refers to a logical reference to either a single device or computer or a group of devices that together act logically as a server.

### 6.2 Registration

User registration can be accomplished using one of several modes: Active, Passive, Enterprise, Dynamic, or by Dynamic Credential Acquisition.

### 6.2.1 Active Registration

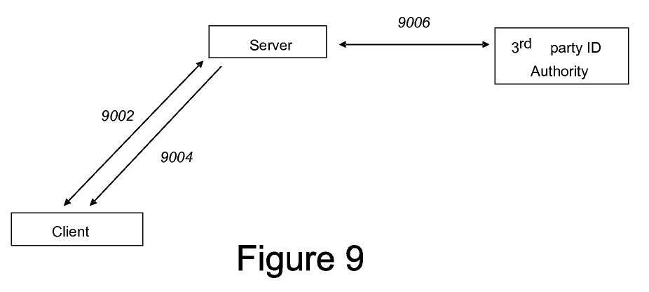

Referring to FIG. 9, with active registration, the user accesses the server (or subparts or nodes of the server) directly and provides information to the server about the identity of that user (9002). The server can then simply register the user based on information provided and download an identifier which is stored in the client and used to identity the client in future communications with the server (9004), or take the information the user provides and authenticate that information against a third party, such as a credit card processor or credit agency, which can authenticate the identity of the user using the provided information (9006). An identifier is then downloaded to the client and used to identity the client to the server for future communications.

### 6.2.2 Passive Registration

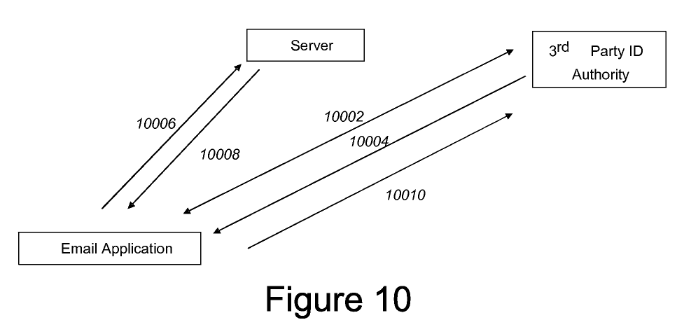

Referring now to FIG. 10, with passive registration, the user first authenticates with a third party and user where that user has a prior relationship, such as a bank or credit agency (10002). Once authenticated, the user downloads and installs software from the third party, or another server representing third party, to the client (10004). The software contains an identifier for the third party which the newly installed client then passes to the server at which time the server then sets up an account for the client and passes a unique identifier back to the client which will be used to identify the client to the server in future communications (10006). The server can also optionally create an additional cross-referenced identifier specifically for the combination of that client and that third party, and can pass the cross-referenced identifier to the client, which then passes that identifier back to the third party, such a that all communications using the system between that user and that third party will exclusively use that cross-referenced identifier (10008). The client then passes the unique identifier or the cross-referenced identifier (a method which protects the third party from viewing the client unique identifier) to the third party when communicating with the third party (10010).

### 6.2.3 Enterprise Registration

Enterprises can be registered using either active or passive registration (just described), or through a manual process (e.g., by a sales person). When an enterprise is registered, the assumption is that there will typically be multiple individual users under the enterprise account. The enterprise itself has a top tier ID while each of these users can also represent different divisions of the enterprise, thus establishing a need for hierarchal identifiers. Enterprises can register secure mail servers which are meant to route mass mail, such as account statements, from the enterprise, or can allow individuals to register. When either type of entity is registered within the enterprise, that entity can be assigned a sub-tier ID within the hierarchy of the enterprises account. The combination of top tier IDs plus the lower tier IDs for any user account forms the identifier.

### 6.2.4 Dynamic Registration

In some embodiments, registration is also accomplished using Dynamic Registration (DR). Dynamic registration leverages a preexisting internet account relationship to identify and authenticate a new user X on the system and to establish a trusted electronic relationship (TER) between two parties. Thus, for Dynamic Registration, user X already has a prior business relationship with business Y such that user X has a means by which to electronically authenticate user X's identity to business Y such as by logging into business Y's website. For example, a user X logs into an account management of a website (web or other computer interface). Once a user X is logged in, user X identified and user X can download software to enable exchange sensitive documents/files with the business Y which operates said site (as well exchange documents with other entities) and is pre-configured with user X's identity embedded in the code from within the user account management area of that site. When installed, user X's software will perform a handshake with the software installed at business Y (could be same or different server as used in previous steps). Then software at both business Y and user X will notify the secure sever that the other is now a credentialed exchange partner. The Secure server adds a record of the credentials to each said entities' accounts, noting the credentialed partner status. At any point after user X has logged into his account at Business Y, and during the setup session described above, the system may optionally prompt user X to choose an electronic signature (in the form or a secret pass code, signature code or other method). This can be through an exchange with Business Y or through an exchange with the server. In either case, the electronic signature is stored in the customer record at the CS and/or at Business Y and can be used to identity the user (as opposed to just the PC) in future file/document exchanges between the two parties.

Thus, when said user uses the software to exchange documents and files with business Y where the preexisting account relationship existed, the software can exchange credentials, effectively communicating the identity of user X to said business Y; and business Y is provided a high level of confidence that the identity of user X when exchanging files or documents with user X using the system. In addition, user X will also be provided a high level of confidence of the identity of business Y when receiving or exchanging documents with business Y. This can be done with a direct exchange of credentials by exchanging ID tokens where those tokens are cross referenced to an account on a database at Business Y (or user X) or by exchanging tokens and performing an identification lookup at the server (where the server has maintained a cross-referenced record of the user X account number at business Y), or a combination of both.

### 6.2.5 Dynamic Credential Acquisition (DCA)

In another embodiment, DCA allows a user X who has previously installed the UDXSC software, but has not yet authenticated at business Z, to authenticate with business Z such that a TER is established between the two parties, i.e. business Z can now trust the identity of user X when communicating with user X using the system and so that user X can trust the identity of business Z when communicating with business Z.

Using DCA, a user X, who already has installed the above-described software, already has a prior business relationship with business Z such that user X has a means by which to electronically authenticate user X's identity to business Z such as by logging into business Z's website. User X logs into an account management area of a website (web or other computer interface). Once a user X is logged in, user X identified by business Z (i.e. because the user has authenticated when logging into business Z's website), UDXSC software on both sides (internet account server and user X side) can exchange IDs (or a cross-referenced version such as an email address or a combination thereof). Both applications send a secure electronic message to the UDX CS (central server) requesting that the other entity be added as a credentialed entity for that user's account. The CS records this in the appropriate customer records. Business Z then associates this ID with user X's existing user account at Business Z and stores this association as a record at the CS (this association can also be communicated and kept at the business Z, however, if user X's ID changes, then the association will no longer be valid thus a separate identifier, such as the email address can be used for the local association). Thus, when user X receives a document or file from business Z, software on user X's computer can display a visible icon or message stating that business Z is a credentialed exchange partner with user X and vice versa by performing a simple lookup at the server. Thus, both user X and Business Z are authenticated when exchanging files and documents in the same way as with Dynamic Registration above, but without downloading software.

### 6.3 Leveraged Associative Trusted Electronic Relationship (LATER)

In another embodiment, once a user is registered on the system as described above, that user has established some degree (depending on the method used) of a trusted electronic relationship (TER) on the system. This TER is between two parties where one user has used Dynamic Registration or DCA (both above) to establish that relationship. With both Dynamic Registration and DCA above, the two parties had prior TER, such as between a customer and that customer's online account at his bank, which was then leveraged to create TER on the described system of the invention.

The established TER in the system can also be leveraged in reverse to establish TER between two entities that does not exists at the time communication is established. For example, once a users identity is established on the system, that identity can be used to identify that user electronically to another entity where a prior TER did not exist.

Thus, using LATER, one entity can effectively act as a trusted authority for another entity on the system to establish the identity of new customers or simply to establish TER between the two parties.

When LATER is used between a business and a customer, the system can typically be used in two ways:
1) As a completely new customer setting up an electronic relationship; or
2) As an existing customer that simply needs to be identified when setting up an electronic relationship.

With LATER, two parties, User A and User B, would typically be enabled on the system, but have not established a TER. If one user entity using the system, for example, User A, has an established TER with a third party user, say User C, then User B could utilize the LATER system as follows. (Users described below have installed the above-described software and have records on the secure server. The following describes the logical communications and relationships among the parties using the installed software. Any one of the parties can be an individual or a business, however, typically user A would be an individual setting up an account with user B (a business) and leveraging a business relationship between user C (another business). User A and user C do not have established a TER (trusted electronic relationship) with each other, but do have a TER directly with the server (or the secure server) or another entity via the server.

### 6.3.1 Method 1

User A requests to establish a TER with user B and forwards a unique identifier, which can be used to identify user A at the server, to user B along with other inputted (by the user) identifying information, such as name address, etc (7002). User B forwards the unique identifier and other identifying information to the server requesting authentication (7004). The server performs a lookup to determine if the information provided matches the identification information at the server, and then sends a verification (positive or negative) to user B (7006). Upon request by user B, the server can record user A as a trusted exchange partner (7008) and user X's email address, and other identifying information returned to user B by the server, is stored at user B associating user A with any account setup or other business relationship at user B. Note that technically, only one of either steps at the client or server is needed to establish the relationship (TER).

Using Method 1, the quality of the AQ established is the same between user B and user A as it was for whatever method user A initially established an identity with the server. This could be through a direct registration process with the server, or could be through a registration with another user, such as user C and user C has provided the server with personally identifiable information about user A which user C needs authenticated, such as physical address or possibly a social security number.

### 6.3.2 Method 2

Using Authentication Partners as described above, user A has established an authentication partner, user C. The authentication partner would typically be a trusted institution, such as a bank, which has the capability of authenticating a user at a high confidence level, i.e., providing a high registration AQ and has done so to establish a registration AQ (or simply the identity of) user A. While typically a trusted institution, the authentication partner could be any other user on the system. The authentication partner, in effect, acts as a reference or witness to user A's identity when user A is establishing a new TER with another entity in this case, user B. User A could choose other users, where a TER has been established, on the system to serve as secondary, or tertiary authentication partners and so on.

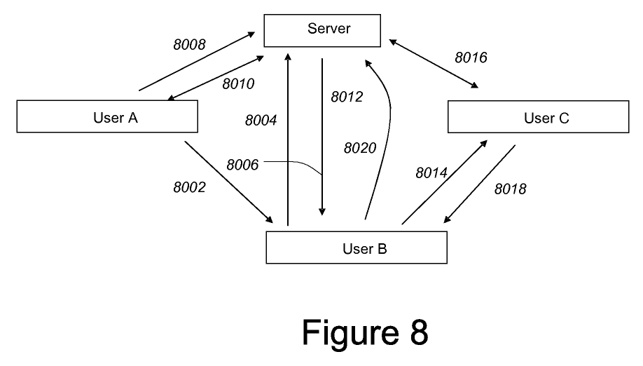

Referring now to FIG. 8, user A requests to establish a TER with user B and forwards a UDXSC unique identifier, which can be used to identify user A at the server, to user B along with other inputted (by the user) identifying information, such as name address, etc (8002). User B forwards the unique identifier and other identifying information to the server requesting authentication (8004).

Optionally an electronic signature can be requested (8006). User A pings the server regularly. Because a transaction is active and user B has requested authentication (8008), the server responds to the regular ping of User A with a request to input an electronic signature (pass code or other) (8010). User A does so.

The server performs a lookup in user A's account and responds to user B with the address of user A's authentication partner (8012), user C and a unique registration transaction number. User B then directs a request, the message include the unique registration transaction number (8014), to User C requesting identification credentials such as address, telephone number etc (8016). User C. (using this method, user personal information is not stored at the server) runs a check against the server to make sure the transaction is legitimate using the unique registration transaction number. Upon a positive response, user C responds to user B with the requested information (8018) and can setup an account for user X, and notfies the server that at TER has been established between user A and user B (8020). The server records the relationship in the records for both user A and user B.

Using Method 2, the quality the AQ established (confidence level of the identification) is the same between user B and user A as it is between user A and user C.

### 7 COMPUTER IMPLEMENTATION

The software, systems, and methods described herein can be implanted on a standard general purpose computer using methods known to those of ordinary skill in the art. A representative computer includes a central processing unit (CPU) which is coupled bidirectionally with random access memory (RAM) and unidirectionally with read only memory (ROM). Typically, RAM is used as a “scratch pad” memory and includes programming instructions and data, including distributed objects and their associated code and state, for processes currently operating on CPU. ROM typically includes basic operating instructions, data and objects used by the computer to perform its functions. In addition, a mass storage device, such as a hard disk, CD ROM, magneto-optical (floptical) drive, tape drive or the like, is coupled bidirectionally with CPU. Mass storage device generally includes additional programming instructions, data and objects that typically are not in active use by the CPU, although the address space may be accessed by the CPU, e.g., for virtual memory or the like. Each of the above described computers optionally includes an input/output source that typically includes input media such as a keyboard, pointer devices (e.g., a mouse or stylus) and/or network connections. Additional mass storage devices (not shown) may also be connected to CPU 32 through a network connection. It will be appreciated by those skilled in the art that the above described hardware and software elements, as well as networking devices, are of standard design and construction, and will be well familiar to those skilled in the art.

### 8 CONCLUSION

The present invention will be seen to provide systems, methods, and software for the exchange of electronic information securely and with confirmation of authenticity. Although various specific embodiments and examples have been described herein, those having ordinary skill in the art will understand that many different implementations of the invention can be achieved without departing from the spirit or scope of this disclosure. For example, encryption and decryption can be performed using a single software module or more than two software modules. The modules described herein can be implemented using a variety of techniques and can be part of the operating system as well as plug-ins. Still other variations will be clear to those having ordinary skill in the art.

What is claimed:

1. A system for secure electronic information exchange, comprising:
a secure electronic communications server computer in secure electronic communication with at least one sender of electronic information and at least one receiver of electronic information, said secure electronic communications server computer being configured to receive securely electronic information sent from said at least one sender of electronic information addressed to said at least one receiver of electronic information and forward securely said electronic information to said at least one receiver of said electronic information;
a database including descriptive information of said least one sender of electronic information and said at least one receiver of electronic information, said descriptive information being effective to enable the authentication of said at least one sender of electronic information and said at least one receiver of electronic information; and
said secure electronic communications server computer being further configured to provide at least one estimation of confidence in said authentication.

2. The system of claim 1, wherein said estimation of confidence is an Authenticity Quotient.

3. The system of claim 2, where said Authenticity Quotient comprises a Registration AQ factor and a Signing AQ factor.

4. The system of claim 3, further including at least one secure client computer that is configured to receive instructions from said secure server computer to establish a secure connection with at least one additional secure server computer and receive secure electronic communications from said at least one additional secure server computer.

5. The system of claim 1, further including at least one secure client computer that is configured to receive instructions for said secure server computer to establish a secure connection with at least one additional secure server computer and receive secure electronic communications from said at least one additional secure server computer.

6. A computer-readable medium containing computer program code devices thereon, said computer program code devices configured to enable a computer to perform secure electronic information exchange, said computer program code devices comprising:
computer program code devices configured to provide a secure electronic communications server computer in secure electronic communication with at least one sender of electronic information and at least one receiver of electronic information, said computer program code devices being further configured to provide secure electronic communications server computer that can receive securely electronic information sent from said at least one sender of electronic information addressed to said at least one receiver of electronic information and forward securely said electronic information to said at least one receiver of said electronic information;
computer program code devices configured to provide a database including descriptive information of said least one sender of electronic information and said at least one receiver of electronic information, said descriptive information being effective to enable the authentication of said at least one sender of electronic information and said at least one receiver of electronic information; and
computer program code devices configured to provide at least one estimation of confidence in said authentication.

7. The computer-readable medium of claim 6, wherein said estimation of confidence is an Authenticity Quotient.

8. The computer-readable medium of claim 7, where said Authenticity Quotient comprises a Registration AQ factor and a Signing AQ factor.

9. The computer-readable medium of claim 8, further including computer program code devices configured to enable at least one secure client computer to request a direct connection with said secure server computer and receive secure electronic communications directly from said secure server computer.

10. The computer-readable medium of claim 9, wherein said at least one receiver of electronic information is located at said secure client computer, and said secure server computer is the server of origin for electronic communications sent to said client computer from said at least one sender of electronic information.

11. The computer-readable medium of claim 6, further including computer program code devices configured to enable at least one secure client computer to request a direct connection with said secure server computer and receive secure electronic communications directly from said secure server computer.

12. The computer-readable medium of claim 11, wherein said at least one receiver of electronic information is located at said secure client computer, and said secure server computer is the server of origin for electronic communications sent to said client computer from said at least one sender of electronic information.

13. A method for secure electronic information exchange, comprising:
providing a secure electronic communications server computer in secure electronic communication with at least one sender of electronic information and at least one receiver of electronic information, said secure electronic communications server computer being configured to receive securely electronic information sent from said at least one sender of electronic information addressed to said at least one receiver of electronic information and forward securely said electronic information to said at least one receiver of said electronic information;
providing a database including descriptive information of said least one sender of electronic information and said at least one receiver of electronic information, said descriptive information being effective to enable the authentication of said at least one sender of electronic information and said at least one receiver of electronic information; and
providing at least one estimation of confidence in said authentication.

14. The method of claim 13, wherein said estimation of confidence is an Authenticity Quotient.

15. The method of claim 14, where said Authenticity Quotient comprises a Registration AQ factor and a Signing AQ factor.

16. The method of claim 15, further including providing at least one secure client computer that is configured to request a direct connection with said secure server computer and receive secure electronic communications directly from said secure server computer.

17. The method of claim 13, further including providing at least one secure client computer that is configured to request a direct connection with said secure server computer and receive secure electronic communications directly from said secure server computer.

18. The method of claim 17, wherein said at least one receiver of electronic information is located at said secure client computer, and said secure server computer is the server of origin for electronic communications sent to said client computer from said at least one sender of electronic information.

19. A system for secure electronic information exchange, comprising:
at least one secure client computer that is configured to receive electronic instructions from a first secure server computer to establish a secure connection with at least one additional secure server computer and receive secure electronic communications from said at least one additional secure server computer, said first server computer being configured to a secure electronic communications server computer in secure electronic communication with at least one sender of electronic information and at least one receiver of electronic information, said secure electronic communications server computer being configured to receive securely electronic information sent from said at least one sender of electronic information addressed to said at least one receiver of electronic information and forward securely said electronic information to said at least one receiver of said electronic information; and said first in electronic communication with a database including descriptive information of said least one sender of electronic information and said at least one receiver of electronic information, said descriptive information being effective to enable the authentication of said at least one sender of electronic information and said at least one receiver of electronic information.

20. The system of claim 19, wherein said at least one secure client computer is further configured to receive at least one estimation of confidence in said authentication from said first secure server.
